(19) United States
(12) Patent Application Publication
(10) Pub. No.: US 2003/0039373 A1
(43) Pub. Date: Feb. 27, 2003

(54) Methods and apparatus for mixer with cue mode selector

(75) Inventors: Adam Lawson, Meridian, MS (US); Elon Ray Coats, Meridian, MS (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Peavey Electronics Corporation, Meridian, MS

(21) Appl. No.: 10/125,919

(22) Filed: Apr. 19, 2002

Related U.S. Application Data
(60) Provisional application No. 60/314,743, filed on Aug. 24, 2001.

(51) Int. Cl. H04B 1/20; H04B 1/00

(52) U.S. Cl. 381/119; 369/3

(57) ABSTRACT

An audio mixer includes: a cross-fader circuit operable to produce a first intermediate signal that includes respective proportions of a first signal and a second signal; an effects circuit operable to alternately send a cue signal (one of the first and second signals) and the first intermediate signal to an effects processor, and to receive an effects return signal from the effects processor in response thereto; and a monitoring circuit operable to receive the program signal (the other of the first and second signals), the cue signal, and the effects return signal and to produce a mixed signal including, in the alternative, respective proportions of (i) the cue signal and the effects return signal; (ii) the program signal and the cue signal; and (iii) the program signal and the effects return signal, wherein the mixed signal is for output from the audio mixer via a headphone output such that a user of the audio mixer is capable of hearing the mixed signal but the audience is not capable of hearing the mixed signal.

### CROSS REFERENCE TO RELATED APPLICATIONS

This application claims the benefit of U.S. Provisional Patent Application No. 60/314,743, filed Aug. 24, 2001, entitled CLUB-MIX MULTI-MODE HEADPHONE CUE CIRCUITRY, the entire disclosure of which is hereby incorporated by reference.

### BACKGROUND OF THE INVENTION

The present invention relates to a mode selector switch for a mixer that enables a user to change the source of a signal present in his headphones (or booth), such as to a mix of a selected signal and the same signal after it has been passed through an effect processor, without subjecting an audience to the mix.

Conventional disc jockey (DJ) mixers are capable of receiving two or more stereo signals and cross-fading between them such that the audience (or house) is capable of hearing either of the two signals alone or a mix between them. For example, the house may be listening to a popular song input to a first channel of the mixer, which is achieved by moving a cross-fader control on the mixer to select the signal in the first channel without any contribution from a song input to a second channel of the mixer. In this scenario, the signal input into the first channel and delivered to the house is often called the “program signal.” While the program signal is playing to the house, the DJ may wish to cross-fade to the signal input to the second channel (called a cue signal) by moving the cross-fader control into positions that permit a mix of the program signal and the cue signal.

In order to achieve a pleasing mix of the program signal an the cue signal for the house, it is desirable to permit the DJ to preview the mix of the program signal and the cue signal while the program signal is playing to the house without playing the mix to the house. This is achieved in conventional DJ mixers by permitting the DJ to monitor a mix of the program signal and the cue signal by way of a headphone output from the mixer. In this way, the DJ may adjust gain levels and timing of the cue signal relative to the program signal to achieve a pleasing mix without subjecting the house to such adjustments. The DJ may then re-cue the cue signal in preparation for a cross-fade between the program signal and the cue signal for the house.

DJs are now interested in using special effects to alter the audible characteristics of at least one of the program signal, the cue signal, and/or the mix therebetween. Indeed, companies such as Yamaha, Roland, Korg, etc. are making effects processors especially for DJs. Such effects processors may include a delay effect, a flange effect, and a sample/playback effect. Unfortunately, many of the conventional DJ mixers do not include an effect send output, i.e., an output that provides the cross-fader signal (the mixed signal) to an effects processor. Of those DJ mixes that do provide an effects send output, such conventional DJ mixers do not permit the DJ to preview the effect that the effects processor will have on the program signal, the cue signal, and/or the cross-fader signal without playing it to the house. Thus, the DJ is left to guess at the proper adjustments of various parameters, such as gain, delay, modulation rate, sample length, pitch, etc., that might produce a pleasing effect on the program signal, the cue signal, and/or the cross-fader signal. This can obviously lead to significantly undesirable results when the DJ guesses wrong and the audience is subject to a bad mix.

Accordingly, there is a need in the art for new methods and apparatus for permitting a user (e.g., a DJ) to monitor the effects processes on various signals without permitting the audience to listen to same.

### SUMMARY OF THE INVENTION

In accordance with one or more aspects of the present invention, an audio mixer includes: a cross-fader circuit operable to produce a first intermediate signal that includes respective proportions of a first signal and a second signal, each of the first and second signals being selectable by a user as a cue signal or a program signal; an effects circuit operable to alternatively send the cue signal and the first intermediate signal to an effect processor, and to receive an effects return signal from the effects processor in response to the cue signal or the first intermediate signal; and a monitoring circuit operable to receive the cue signal, the program signal, and the effects return signal, and to produce a mixed signal including, in the alternative, respective proportions of (i) the cue signal and the effects return signal; (ii) the program signal and the cue signal; and (iii) the program signal and the effects return signal, wherein the user may listen to the mixed signal but an audience may not listen to the mixed signal.

The effects circuit is preferably further operable to produce a second intermediate signal including respective proportions of the first intermediate signal and the effects return signal, the second intermediate signal being used for producing a main output signal from the audio mixer that the audience may listen to. The audio mixer may include an effects fader operable to adjust the respective proportions of the first intermediate signal and the effects return signal.

The monitoring circuit preferably includes: a switching circuit having a user accessible mode selector switch and being operable to produce third and fourth intermediate signals, the respective third and fourth intermediate signals being, in the alternative: (i) the cue signal and the effects return signal; (ii) the program signal and the cue signal; and (iii) the program signal and the effects return signal, in accordance with the mode selector switch; and a headphone (or booth) circuit having a fader control and being operable to blend the third and fourth intermediate signals in accordance with the fader control to produce the mixed signal.

The effects circuit preferably includes: an effects send output for delivering an effects send signal to the effect processor and an effects return input for receiving the effects return signal; and an effects send switch operable to alternately deliver the first intermediate signal or the cue signal to the effects send output in accordance with the mode selector switch. The effects circuit may also include an effects blend override circuit operable to substantially eliminate the proportion of the effects return signal to mix with the first intermediate signal when the mode selector switch dictates that the respective third and fourth intermediate signals are the cue signal and the effects return signal. The effects blend override circuit is preferably not operable to substantially affect the proportion of the of the effects return signal to mix with the first intermediate signal when the mode selector switch dictates that the respective third and fourth intermediate signals are either of (i) the program signal and the cue signal; and (ii) the program signal and the effects return signal.

Preferably, the cue signal, the program signal, the first intermediate signal, the effects return signal, and the mixed signal include respective left and right stereo signals.

In accordance with one or more further aspects of the present invention, a method includes: producing a first intermediate signal that includes respective proportions of a first signal and a second signal, each of the first and second signals being selectable by a user as a cue signal or a program signal; sending, in the alternative, the cue signal and the first intermediate signal to an effect processor, and receiving an effects return signal from the effect processor in response to the cue signal or the first intermediate signal; and producing a mixed signal including, in the alternative, respective proportions of (i) the cue signal and the effects return signal; (ii) the program signal and the cue signal; and (iii) the program signal and the effects return signal, wherein the user may listen to the mixed signal but an audience may not listen to the mixed signal.

The method preferably further includes producing a second intermediate signal including respective proportions of the first intermediate signal and the effects return signal, the second intermediate signal being used for producing a main output signal from the audio mixer that the audience may listen to. The method preferably permits adjustment to the respective proportions of the first intermediate signal and the effects return signal based on user input.

The method preferably further includes: producing third and fourth intermediate signals, the respective third and fourth intermediate signals being, in the alternative: (i) the cue signal and the effects return signal; (ii) the program signal and the cue signal; and (iii) the program signal and the effects return signal; and blending the third and fourth intermediate signals to produce the mixed signal. The method preferably further includes delivering the first intermediate signal to the effects processor when the respective third and fourth intermediate signals are the program signal and the cue signal, or the program signal and the effects return signal. The cue signal is preferably delivered to the effects processor when the respective third and fourth intermediate signals are the cue signal and the effects return signal.

The proportion of the effects return signal to mix with the first intermediate signal is preferably substantially eliminated when the respective third and fourth intermediate signals are the cue signal and the effects return signal.

In accordance with one or more further aspects of the invention, a method includes: selecting a program signal and a cue signal using an audio mixer such that an audience is capable of hearing the program signal but not the cue signal; producing a first mixed signal using the audio mixer, the first mixed signal including a cue signal and the cue signal subject to an effect process; monitoring the first mixed signal via a headphone (or booth) output of the mixer such that the audience is not capable of hearing the first mixed signal; producing a second mixed signal using the audio mixer, the second mixed signal including the first signal and the first signal subject to the effect process; monitoring the second mixed signal via a headphone (or booth) output of the mixer such that the audience is not capable of hearing the second mixed signal; cross fading between the program signal and the cue signal using a cross fader of the mixer to produce a third mixed signal including the program signal and the cue signal; and producing a mix of the third mixed signal and the third mixed signal subject to the effect process such that the audience is capable of hearing the mix.

Other aspects, features, advantages, etc. will be apparent to one skilled in the art when the written description herein is taken in conjunction with the accompanying drawings.

### BRIEF DESCRIPTION OF THE DRAWINGS

For the purposes of illustrating the invention, there are shown in the drawings, forms that are presently preferred, it being understood, however, that the invention is not limited to the precise arrangements and/or instrumentalities shown.

FIG. 1 is a general block diagram showing at least some features and functions of a mixer in accordance with one or more aspects of the present invention;

FIG. 2 is a more detailed block diagram of certain features of the mixer of FIG. 1 in accordance with one or more further aspects of the present invention;

FIG. 3 is a diagram of a portion of the mixer of FIG. 1 having a mode selector switch in accordance with one or more aspects of the present invention;

FIG. 4 is a schematic diagram of an alternative embodiment of the mixer of FIG. 1;

FIG. 5 is a schematic diagram of an alternative embodiment of the mixer of FIG. 1; and

FIG. 6 is a flow diagram illustrating certain process steps and/or functions of the mixer of FIG. 1 in accordance with one or more aspects of the present invention.

### DESCRIPTION OF THE INVENTION

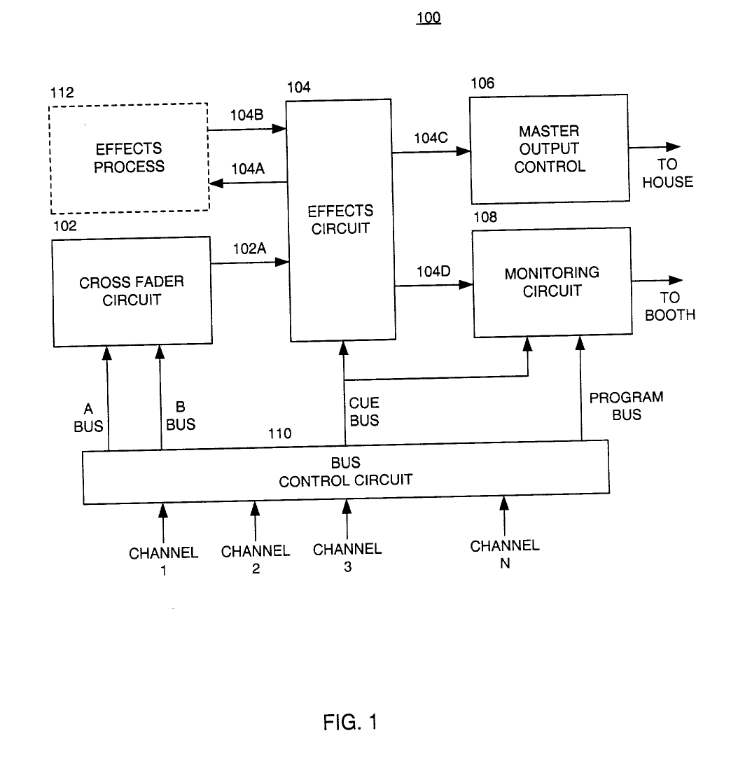

Referring now to the drawings, wherein like numerals indicate like elements, there is shown in FIG. 1 a block diagram illustrating at least some features and functions of a mixer 100 in accordance with one or more aspects of the present invention. The mixer 100, preferably an audio mixer, includes a cross-fader circuit 102, and effects circuit 104, a master output control 106, a monitoring circuit 108, and a bus control circuit 110. The mixer 100 includes several signal buses, namely, an A bus, a B bus, a cue bus, and a program bus to provide signals to the various functional blocks.

The cross-fader circuit 102 is preferably operable to receive first and second signals from the A bus and B bus, respectively, and to produce an intermediate signal on line 102A that includes respective proportions of the first and second signals. Preferably, the cross-fader circuit 102 includes a cross-fader control (having a potentiometer or the like) that is adjustable by the user to change the respective proportions of the first and second signals contained in the intermediate signal on line 102A. It is noted that this intermediate signal may be referred to herein as “the cross-fader signal” or the “dry signal”.

The bus control circuit 110 receives signals from one or more of a plurality of channels, labeled channel 1, channel 2, channel 3 . . . , channel N. The bus control circuit 110 is preferably operable to couple any of the signals of the channels to a selected one of the A bus, the B bus, the cue bus, or the program bus. Although any of the known or hereinafter developed techniques for implementing the bus control circuit 110 may be employed, it is preferred that a respective bus selector switch (not shown) is operable to selectively couple a given one of the channels to the A bus, the B bus, and/or the program bus, while a respective cue selector button is employed to couple a given one of the channels to the cue bus.

The effects circuit 104 is preferably operable to receive the cross-fader signal on line 102A and cue signals over the cue bus. As will be discussed in more detail later in this description, the effects circuit 104 is preferably operable to output certain signals from an effects send connection 104A to an effects process 112. It is preferred that the effects process 112 is implemented by way of external circuitry, although this is not required in order to practice the invention. Any of the known or hereinafter developed effects processes 112 may be employed, such as a delay effect, a flange effect, a sample/playback effect, etc.

The effects circuit 104 preferably receives an effects return signal over a return connection 104B from the effects process 112 and mixes the cross-fader signal (the dry signal) on line 102A with the effects return signal (or “wet signal”) in user selectable proportions. The effects circuit 104 outputs the mix of the cross-fader signal and the effects return signal to the master output control 106 by way of line 104C such that it may be played to the house. The effects circuit 104 preferably outputs a corresponding effects return signal on line 104D to the monitoring circuit 108 for further processing, as will be discussed in more detail hereinbelow.

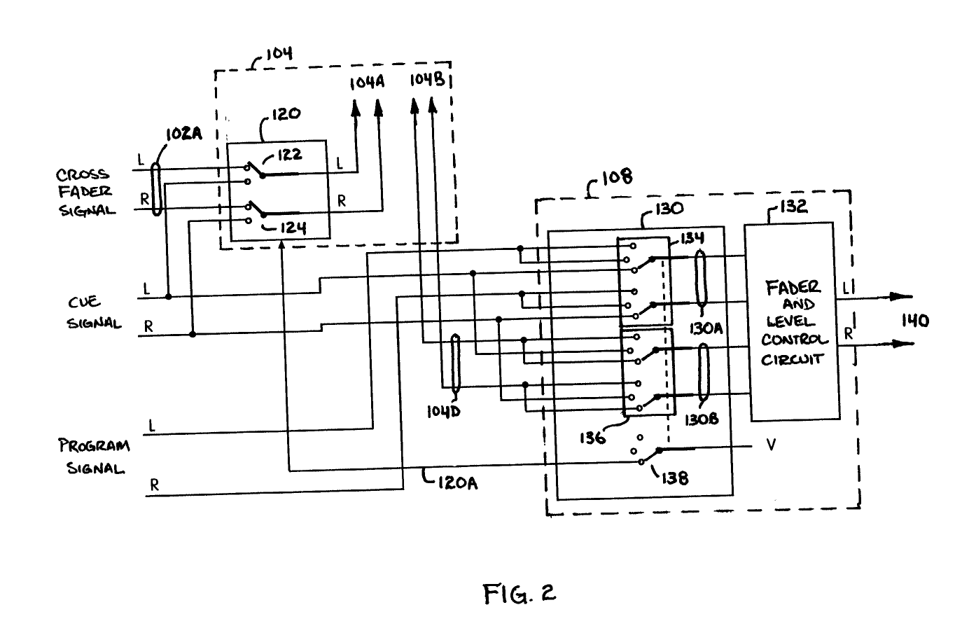

Reference is now made to FIG. 2, which is a more detailed block diagram of certain features of the mixer 100 of FIG. 1. In particular, additional details are provided for the effects circuit 104 and the monitoring circuit 108. It is noted that the block diagram of FIG. 2 shows each of the cross-fader signal, cue signal (on the cue bus), the program signal (on the program bus), and the effects return signal on line 104D as containing left and right stereo components as is preferred in accordance with the invention. It is understood, however, that stereo signaling is not required to practice the invention; indeed, monophonic signals may be employed.

The effects circuit 104 preferably includes an effects send switch 120 that is operable to alternatively deliver the cross-fader signal on line 102A or the cue signal from the cue bus to the effects send output 104A. Preferably, the selection as to which of these signals is delivered to the effects send output 104A is determined in accordance with a switch control signal on line 120A from the monitoring circuit 108. (Further details concerning the switch control signal will be presented later in this description.) Any of the known or hereinafter developed techniques for implementing the effects send switch 120 may be employed without departing from the spirit and scope of the invention. It is preferred that one or more voltage controlled, single-pole, double-throw switches are employed to implement the effects send switch 120. Two such single-pole, double-throw switches 122, 124 are shown in FIG. 2 in order to accommodate a stereo cross-fader signal and a stereo cue signal. Respective left and right signal lines couple the stereo cross-fader signal and the cue signal to respective input terminals of the single-pole, double-throw switches 122-124 and respective left and right signal lines couple the common terminals of these switches to respective left and right effects send outputs of line 104A. It is noted that the one or more single-pole, double-throw switches 122, 124 may be implemented mechanically, electro-mechanically, and/or using solid state devices as will be apparent to one skilled in the art from the description herein. Further details regarding an alternative embodiment of the effects send switch 120 will be presented later in this description.

The monitoring circuit 108 preferably includes a mode selector switch 130 and a fader/level control 132. The monitoring circuit 108 is preferably operable to receive the cue signal (on the cue bus), the program signal (on the program bus), and the effects return signal on line 104D. The monitoring circuit 108 preferably produces a mixed signal including respective proportions of the cue signal, the program signal, and the effects return signal, as may be input to the fader/level control circuit 132, in accordance with user selections made by way of the mode selector switch 130. The fader/level control circuit 132 is preferably operable to mix the signals input thereto on lines 130A and 130B to produce the mixed signal.

The monitoring circuit 108 is preferably operable to produce a mixed signal including, in the alternative, respective proportions of (i) the cue signal and the effects return signal; (ii) the program signal and the cue signal; and (iii) the program signal and the effects return signal. The mixed signal is output over line 140 to, for example, the user's headphones or booth monitoring speakers such that the user may listen to the mixed signal but the audience may not listen to the mixed signal. It is noted that any of the known or hereinafter developed techniques for implementing the mode selector switch 130 may be employed without departing from the spirit and scope of the invention. It is preferred that the function of single-pole, triple-throw switches be employed using, for example, mechanical, electromechanical, and/or solid state components. To this end, the mode selector switch 130 preferably includes a plurality of ganged single-pole, triple-throw switches to alternatively connect the cue signal, the program signal, or the effects return signal to lines 130A and 130B, which input same to the fader/level control circuit 132.

The mode selector switch 130 preferably includes a first pair of single-pole, triple-throw switches 134 having common terminals connected to lines 130A and a second pair of single-pole, triple-throw switches 136 having common terminals coupled to lines 130B. The left and right portions of the program signal are connected to two of the input terminals of the first pair of switches 134, while the left and right portions of the cue signal are connected to the remaining input terminals of the first pair of switches 134. The left and right portions of the effects return signal are coupled to the first and third input terminals of the second pair of switches 136, while the left and right portions of the cue signal are connected to the remaining terminals of the second pair of switches 136. A control switch 138 is provided to connect a voltage V to line 120A to provide the switch control signal to the effects send switch 120. Further details of an alternative embodiment of the mode selector switch 130 will be presented later in this description.

Preferably, the user is permitted to manipulate the mode selector switch 130 in a way that alters the connections between the common terminals of the first and second pair of switches 134, 136 and the control switch 138 in order to achieve desirable monitoring functions. For example, when the user has placed the mode selector switch 130 in a position in which the first and second pair of switches 134, 136 are in the positions shown, i.e., the cue signal is coupled to line 130A and the effects return signal is coupled to line 130B, the mixed signal preferably includes respective proportions of the cue signal and the effects return signal. In this scenario, the effects send switch 120 of the effects circuit 104 outputs the cue signal to the effects send output 104A by way of switches 122, 124. In this way, the effects return signal is the cue signal subject to the effects process 112, which effects return signal is input to the monitoring circuit 108 by way of line 104D.

With reference to FIG. 1, when the effects return signal on line 104B is the cue signal subject to the effects process 112, it is preferred that the effects circuit 104 does not mix the cross-fader signal (the dry signal) on line 102A with the effects return signal (the wet signal) on line 104B for delivery to the master output control 106 over line 104C. Indeed, it is preferred that such a blend is overridden when the user has engaged the mode selector switch 130 (FIG. 2) in a way that causes the effects send switch 120 to output the cue signal over the effects send connection 104A. In this way, the house will not be permitted to hear the cue signal subject to the effects process 112. Further details concerning this blend override will be discussed in more detail later in this description.

Turning again to FIG. 2, when the user manipulates the mode selector switch 130 in a way that causes the first and second pair of switches 134, 136 to connect the program signal to line 130A and the cue signal to line 130B, the mixed signal preferably includes respective proportions of the program signal and the cue signal in accordance with the fader/level control circuit 132. Advantageously, in this scenario the user may monitor various mixing proportions and timing of the program signal and the cue signal in his headphones (or booth) without subjecting the audience thereto.

In a further alternative scenario, when the user manipulates the mode selector switch 130 to cause the first pair of switches 134 to couple the program signal to line 130A and to cause the second pair of switches 136 to couple the effects return signal to line 130B, the mixed signal on line 140 preferably includes respective proportions of the program signal and the effects return signal in accordance with the fader/level control circuit 132. In this scenario, the switch control signal on line 120A causes the effects send switch 120 to connect the cross-fader signal (the dry signal) on line 102A to the effects send output 104A such that the effects return signal on line 104B is the cross-fader signal subject to the effects process 112.

It is noted that when the cross-fader circuit 102 (FIG. 1) is set such that the cross-fader signal on line 102A is substantially the same as the signal on the program bus, then the effects return signal is the program signal subject to the effects process 112. Thus, in this configuration, the mixed signal includes respective proportions of the program signal and the program signal subject to the effects process 112. Advantageously, in this scenario the user is permitted to listen to the mixed signal without subjecting the audience to the same. On the other hand, if the user wishes the house to enjoy a mix of the program signal and the program signal subject to the effects process 112, then he may adjust such blend by way of the effects circuit 104 (FIG. 1) which adjusts respective proportions of the cross-fader signal on line 102A (the dry signal) and the effects return signal on line 104B (the wet signal) for output to the master output control 106 over line 104C.

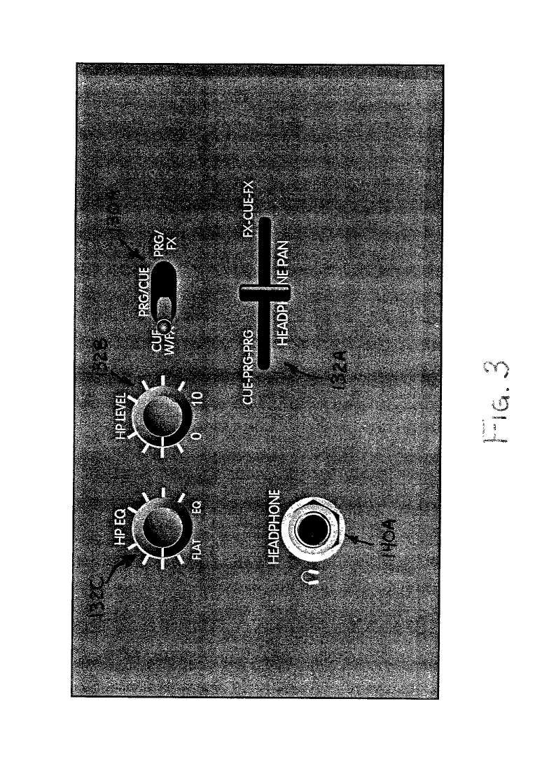

Reference is now made to FIG. 3, which illustrates a preferred implementation/orientation of several user activatable controls of the mixer 100. These controls include a user-activation portion 130A of the mode selector switch 130, a user-activation portion 132A of the fader of the fader/level control circuit 132, a user-activation portion 132B of the level portion of the fader/level control circuit 132, an equalization control 132C, and a headphone jack 140A carrying the mixed signal on line 140.

In operation, the user may position the switch 130A in the CUE W/FX position indicating that the user wishes to monitor a mixed signal containing respective proportions of the cue signal and the cue signal subject to the effects process 112 in his headphones (or booth). The respective proportions of these signals are controlled by the user-activation portion 132A, such as a headphone pan fader. Alternatively, the user may move the switch 130A into the PRG/CUE position indicating his desire to monitor a mixed signal containing respective proportions of the program signal and the cue signal in his headphones. Again, the respective proportions of these signals are determined by the headphone pan fader 132A. When the user manipulates the switch 130A into the PRG/FX position, then the mixed signal preferably includes respective proportions of the program signal and the program signal subject to the effects process 112, where the proportion is determined by the headphone pan fader 132A.

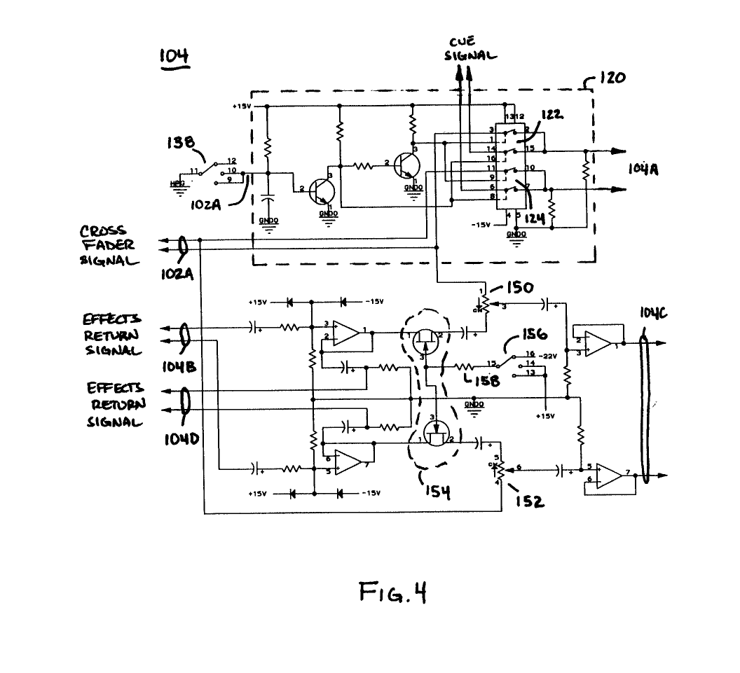

Reference is now made to FIG. 4, which illustrates a schematic diagram of an embodiment of certain portions of the effects circuit 104, namely, the effects send switch 120 and a fader circuit that can mix the cross-fader signal with the effects return signal. Turning first to the effects send switch 120, the first and second switches 122, 124 (FIG. 2) are preferably implemented utilizing four single-pole, single throw, solid state switches that are coupled to the cross-fader signal on line 102A and the cue signal (from the cue bus). The control switch 138 produces the switch control signal on line 120A, which biases a pair of npn transistors in an appropriate way to achieve alternative coupling of the cross-fader signal and the cue signal to the effects send output 104A.

Turning now to the fader circuit, a pair of ganged potentiometers 150, 152 are utilized to produce a mixed signal on line 104C containing respective proportions of the cross-fader signal and the effects return signal. When the cross-fader signal is output to the effects send output 104A (by way of the effects send switch 120), a blend of the cross-fader signal and the cross-fader signal subject to the effects process 112 is output to the master output control 106 (FIG. 1) by way of line 104C. Each of the potentiometers 150, 152 includes a first node coupled to the respective left and right portions of the cross-fader signal, second nodes coupled to the respective left and right portions of the effects return signal, and wiper nodes coupled to the respective left and right portions of line 104C.

The coupling of the effects return signal to the potentiometers 150, 152 includes AC coupling and buffering circuitry, which also results in the corresponding effects return signal on line 104D for input to the monitoring circuit 108. Similarly, AC coupling and buffering circuitry is included from the wiper nodes of the potentiometers 150, 152 to line 104C.

An effects blend override circuit 154 is included between the buffered effects return signal and the potentiometers 150, 152, which is operable to substantially eliminate the proportion of the effects return signal that is mixed with the cross-fader signal when the mode selector switch 130 dictates that the mixed signal on line 140 (FIG. 2) is made up of the cue signal and the effects return signal. As was discussed above, this will prevent the house from hearing the cue signal subject to the effects process 112 when the DJ is listening to (e.g., previewing and adjusting) same in his headphones. Any of the known or hereinafter developed techniques for implementing the effects blend override circuit may be employed without departing from the spirit and scope of the invention. Preferably, the effects blend override circuit is implemented by way of series switches, such as field effect transistors (FETs) having respective input nodes coupled to the effects return signal and respective output nodes coupled to the potentiometers 150, 152. These FET switches are preferably opened when the mode selector switch 130 dictates that the cue signal and the cue signal subject to the effects process 112 are being monitored by the user. As shown, a switch 156 is connected to respective control terminals of the FETs through resistor 158 such that when appropriate bias voltage is applied to same, the FET switches open and close in response.

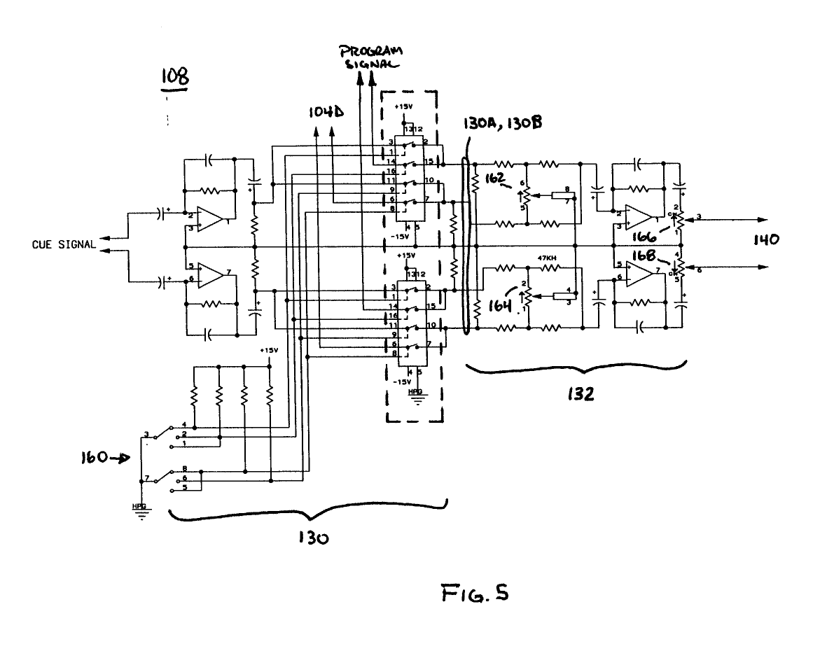

Reference is now made to FIG. 5, which is a schematic diagram of an alternative embodiment of certain portions of the monitoring circuit 108. In particular, circuit details concerning the mode selector switch 130 and the fader/level control circuit 132 are shown. Turning first to the mode selector switch 130, the cue signal is subject to AC filtering and buffering prior to input to the respective switches 134, 136. The program signal is input to the switches 134, 136 by way of the program bus. The effects return signal is input to the switches 134, 136 by way of line 104D. As shown, switches 134, 136 are implemented by way of solid state, single-pole, single-throw switches that exhibit make/break characteristics in response to bias signals provided by single-pole, triple-throw switches 160 connected to respective bias resistors and bias voltage. The outputs of the switches 134 and 136 are coupled to lines 130A and 130B, respectively. The fader/level control circuit 132 preferably includes a fader control operable to adjust respective proportions of the signals on lines 130A and 130B. Although any of the known or hereinafter developed technologies may be employed to implement the fading function, a pair of potentiometers 162, 164 are preferably employed to adjust the respective proportions of the signals on lines 130A, 130B that are output to lines 140. Filtering and buffering circuitry is employed between the potentiometers 162, 164 and a second pair of potentiometers 166, 168, which provide level control.

Many methods may be practiced in accordance with the invention, such as using the mixer 100 for producing a first intermediate signal (such as the cross-fader signal) that includes respective proportions of a first signal (such as the program signal) and a second signal (such as the cue signal); sending the cue signal or the first intermediate signal to an effect processor (such as the effects process 112), and receiving an effects return signal from the effect processor in response thereto; and producing a mixed signal including, in the alternative, respective proportions of (i) the cue signal and the effects return signal, (ii) the program signal and the cue signal, and (iii) the program signal and the effects return signal. Advantageously, this process is carried out such that the user may listen to the mixed signal but the audience (or house) may not listen to the mixed signal.

Alternatively, a method in accordance with various aspects of the invention may include outputting a first signal (such as the program signal) from the audio mixer 100 such that the house is capable of hearing the program signal; and monitoring a mixed signal including a second signal (such as the cue signal) and the cue signal subject to one or more effect processes (e.g., the effects process 112) via the headphone (or booth) output 104A of the mixer 100 such that the audience is not capable of hearing the mixed signal. In a further alternative, a method in accordance with one or more aspects of the invention may include outputting the program signal from the audio mixer 100 such that the audience is capable of hearing the same; and monitoring a mixed signal including the program signal and the program signal subject to the one or more effect processes (such as the effects process 112) via the headphone output 104A of the mixer 100 such that the audience is not capable hearing the mixed signal.

In either case, this advantageously permits the user to adjust various parameters of the effects process 112 with respect to whichever signal or signals are to be mixed therewith. For example, when the effects process 112 is a delay effect, the length of the delay may be adjusted by the user to obtain a desirable length of delay and, therefore, a pleasing mix when the delay effect is employed. Alternatively, the effects process 112 may include a flange effect and the parameters may include a modulation rate. Still further, the effects process 112 may include a sample/playback effect and the parameters may include the sample rate and pitch. It is understood that these are merely examples of the many effects processes presently known, although any other known or hereinafter developed effects may be employed without departing from the spirit and scope of the invention.

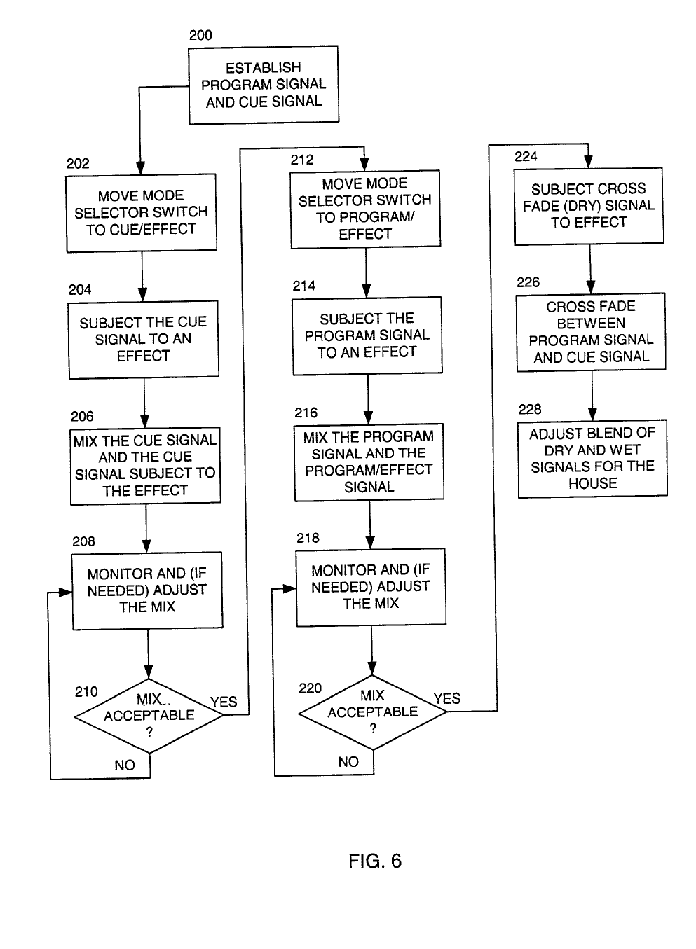

With reference to FIG. 6, still further alternative methods may be practiced in accordance with the present invention. In particular, at action 200, the user may establish a program signal and a cue signal, such as by selecting the program signal and the cue signal utilizing the bus control circuit 110 (FIG. 1). In this way, the audience is capable of hearing the program signal but not the cue signal. At action 202, the user may move the mode selector switch 130A (FIG. 3) to the CUE W/FX position indicating that he wishes to monitor a mix of the cue signal and the cue signal subject to the effects process 112 by way of, for example, his headphones. At action 204, the cue signal is subject to an effect, such as a delay effect, a flange effect, and/or a sample/playback effect as may be carried out by the effects process 112. At action 206, the cue signal and the cue signal to the subject to the effect are mixed and output to the users headphones (e.g., by way of output 104A). At action 208, the user may adjust the mix by setting gain levels and/or other effects parameters, etc. to obtain a desired result (action 210 mix acceptable, yes or no?).

If the mix is acceptable at action 210, the process preferably advances to action 212, where the user moves the mode selector switch 130A (FIG. 3) to the PRG/FX position indicating that he wishes to monitor a mixed signal containing the program signal and the program signal subject to the effects process 112. At action 214, the program signal is subject to such effect and at action 216 the program signal and the program signal subject to the effect are mixed. At action 218, the user monitors the mix and adjusts the mix (e.g., by way of gain levels, effects parameters, etc.) until a desirable mix is obtained action 220 (mix acceptable, yes or no?).

It is noted that the sequence of actions 202-210 are shown being performed prior to the sequence of actions 212-220, although it is understood that actions 212-220 may be performed prior to actions 202-210. Further, other sequences of actions may be performed prior to, during, or after the above sequences without departing from the spirit and scope of the invention. In any case, when the user is satisfied with the audible quality of the respective mixes of (i) the cue signal and the cue signal subject to the effect; and (ii) the program signal and the program signal subject to the effect (and perhaps the program signal mixed with the cue signal), the process flow preferably advances to action 224 where the cross-fader signal is subject to the effect and, at action 226 the user cross-fades between the program signal and the cue signal. With reference to FIG. 1, the cross-fade action may be achieved when the A bus carries the program signal, the B bus carries the cue signal and the user cross-fades using the cross-fader circuit 102. At action 228, the user may adjust the blend of the cross-fader (dry) signal and the effects return (wet) signal for the enjoyment of the house.

Advantageously, the user is permitted to preview the respective mixes of the cue signal, the cue signal subject to the effect, the program signal, and the program signal subject to the effect so that when the user cross-fades between the program signal and the cue signal (action 226) the user is confident that the resultant mix (including the effect on such signals) will be of a known, high quality character.

Further aspects and/or scenarios of the invention may be characterized as follows: in accordance with at least one aspect of the present invention, the mode selector switch 130 includes: a switch or button that changes the signal present in the headphones to include the signal that is sent to the master output control, along with that same signal after it has been passed through one or more effects processors.

In accordance with at least one further aspect of the present invention, the mode selector switch 130 includes: a switch or button that changes the signal present in the headphones to include the signal that is selected by a cue select button along with that same signal after it has been passed through one or more effects processors.

In accordance with at least one further aspect of the present invention, the mode selector switch 130 includes: a switch or button that changes the signal present in the headphones to the signal selected by a cue select button and the signal present at the master output control.

In accordance with at least one further aspect of the present invention, the mode selector switch 130 includes: a switch or button that changes the signal sent to the one or more effects processors from the main signal to the signal selected by the cue select button.

In accordance with at least one further aspect of the present invention, the mode selector switch 130 includes: a switch or button that mutes the outputs of the one or more effects processors to the master output control, when the signal is sent to the one or more effects processors.

Advantages of the invention include permitting a user to listen to a mix of a cue signal and the cue signal subject to one or more effect processes via the headphone output of the mixer while the house (audience) hears the program signal—without subjecting the house to the mix. Thus, the user can adjust the relative proportions of the cue signal and the cue signal subject to the one or more effects processes and/or various effect parameters well prior to playing the cue signal as a program signal to the house. The user may also listen to a mix of the program signal and the program signal subject to one or more effect processes without subjecting the house to the mix.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An audio mixer, comprising:
a cross-fader circuit operable to produce a first intermediate signal that includes respective proportions of a first signal and a second signal, each of the first and second signals being selectable by a user as a cue signal or a program signal;
an effects circuit operable to alternatively send the cue signal and the first intermediate signal to an effect processor, and to receive an effects return signal from the effects processor in response to the cue signal or the first intermediate signal; and
a monitoring circuit operable to receive the cue signal, the program signal, and the effects return signal, and to produce a mixed signal including, in the alternative, respective proportions of (i) the cue signal and the effects return signal; (ii) the program signal and the cue signal; and (iii) the program signal and the effects return signal,
wherein the user may listen to the mixed signal but an audience may not listen to the mixed signal.

2. The audio mixer of claim 1, wherein the effects circuit is further operable to produce a second intermediate signal including respective proportions of the first intermediate signal and the effects return signal, the second intermediate signal being used for producing a main output signal from the audio mixer that the audience may listen to.

3. The audio mixer of claim 2, wherein the effects circuit includes an effects fader operable to adjust the respective proportions of the first intermediate signal and the effects return signal.

4. The audio mixer of claim 2, wherein the monitoring circuit includes:
a switching circuit having a user accessible mode selector switch and being operable to produce third and fourth intermediate signals, the respective third and fourth intermediate signals being, in the alternative: (i) the cue signal and the effects return signal; (ii) the program signal and the cue signal; and (iii) the program signal and the effects return signal, in accordance with the mode selector switch; and
a headphone (or booth) circuit having a fader control and being operable to blend the third and fourth intermediate signals in accordance with the fader control to produce the mixed signal.

5. The audio mixer of claim 4, wherein the effects circuit includes:
an effects send output for delivering an effects send signal to the effect processor and an effects return input for receiving the effects return signal; and
an effects send switch operable to alternatively deliver the first intermediate signal or the cue signal to the effects send output in accordance with the mode selector switch.

6. The audio mixer of claim 5, wherein the effects circuit includes an effects blend override circuit operable to substantially eliminate the proportion of the effects return signal to mix with the first intermediate signal when the mode selector switch dictates that the respective third and fourth intermediate signals are the cue signal and the effects return signal.

7. The audio mixer of claim 6, wherein the effects blend override circuit is not operable to substantially affect the proportion of the of the effects return signal to mix with the first intermediate signal when the mode selector switch dictates that the respective third and fourth intermediate signals are either of (i) the program signal and the cue signal; and (ii) the program signal and the effects return signal.

8. The audio mixer of claim 6, wherein:
the effects circuit includes a potentiometer circuit having a first node coupled to the first intermediate signal, a second node, and a wiper arm node having the second intermediate signal thereon; and
the effects blend override circuit includes a series switch having an input node coupled to the effects return signal and an output node coupled to the second node of the potentiometer circuit, the series switch being opened when the mode selector switch dictates that the respective third and fourth intermediate signals are the cue signal and the effects return signal.

9. The audio mixer of claim 8, wherein the series switch includes a field effect transistor (FET) having one of a drain and source as the input node, the other of the drain and source as the output node, and a gate coupled to the series switch such that a bias voltage is applied to the gate sufficient to open the FET when the mode selector switch dictates that the respective third and fourth intermediate signals are the cue signal and the effects return signal.

10. The audio mixer of claim 1, wherein the cue signal, the program signal, the first intermediate signal, the effects return signal, the mixed signal include respective left and right stereo signals.

11. A method, comprising:
producing a first intermediate signal that includes respective proportions of a first signal and a second signal, each of the first and second signals being selectable by a user as a cue signal or a program signal;
sending, in the alternative, the cue signal and the first intermediate signal to an effect processor, and receiving an effects return signal from the effect processor in response to the cue signal or the first intermediate signal; and
producing a mixed signal including, in the alternative, respective proportions of (i) the cue signal and the effects return signal; (ii) the program signal and the cue signal; and (iii) the program signal and the effects return signal,
wherein the user may listen to the mixed signal but an audience may not listen to the mixed signal.

12. The method of claim 11, further comprising producing a second intermediate signal including respective proportions of the first intermediate signal and the effects return signal, the second intermediate signal being used for producing a main output signal from the audio mixer that the audience may listen to.

13. The method of claim 12, further comprising permitting adjustment to the respective proportions of the first intermediate signal and the effects return signal based on user input.

14. The method of claim 12, further comprising:
producing third and fourth intermediate signals, the respective third and fourth intermediate signals being, in the alternative: (i) the cue signal and the effects return signal; (ii) the program signal and the cue signal; and (iii) the program signal and the effects return signal; and
blending the third and fourth intermediate signals to produce the mixed signal.

15. The method of claim 14, further comprising delivering the first intermediate signal to the effects processor when the respective third and fourth intermediate signals are the program signal and the cue signal, or the program signal and the effects return signal.

16. The method of claim 15, further comprising delivering the cue signal to the effects processor when the respective third and fourth intermediate signals are the cue signal and the effects return signal.

17. The method of claim 16, further comprising substantially eliminating the proportion of the effects return signal to mix with the first intermediate signal when the respective third and fourth intermediate signals are the cue signal and the effects return signal.

18. The method of claim 11, wherein the cue signal, the program signal, the first intermediate signal, the effects return signal, the mixed signal include respective left and right stereo signals.

19. A method, comprising:
outputting a first signal from an audio mixer such that an audience is capable of hearing the first signal; and
monitoring a mixed signal including a second signal and the second signal subject to one or more effect processes via a headphone (or booth) output of the mixer such that the audience is not capable of hearing the mixed signal.

20. The method of claim 19, wherein the monitoring step includes adjusting at least one of (i) proportions of the second signal and the second signal subject to one or more effects processes of the mixed signal; and (ii) one or more parameters of the one or more effects processes to which the second signal is subject.

21. The method of claim 20, wherein the one or more effect processes include at least one of (i) a delay effect and the one or more parameters include a length of delay; (ii) a flange effect and the one or more parameters include a modulation rate; and (iii) a sample/playback effect and the one or more parameters include at least one of a sample rate and a pitch.

22. The method of claim 19, further comprising selecting the second signal to be included in the mixed signal by engaging a cue select button of the mixer.

23. The method of claim 19, further comprising:
cueing the second signal up on the mixer; and
causing the mixer to fade between the first and second signals such that the second signal is output from the mixer and the audience is capable of hearing the second signal instead of the first signal.

24. The method of claim 23, further comprising fading between the first and second signals such that the audience is capable of hearing a mix of the first and second signals for at least some period of time.

25. The method of claim 23, further comprising increasing a blend of the second signal and the second signal subject to the one or more effect processes in the mixer such that the audience is capable of hearing the blend.

26. A method, comprising:
outputting a first signal from an audio mixer such that an audience is capable of hearing the first signal; and
monitoring a mixed signal including the first signal and the first signal subject to one or more effect processes via a headphone (or booth) output of the mixer such that the audience is not capable of hearing the mixed signal.

27. The method of claim 26, further comprising increasing a blend of the first signal and the first signal subject to the one or more effect processes in the mixer such that the audience is capable of hearing the blend.

28. The method of claim 26, further comprising increasing a blend of the first signal subject to the one or more effect processes in the mixer such that the audience is capable of hearing the first signal subject to the one or more effect processes.

29. The method of claim 28, wherein the monitoring step includes adjusting at least one of (i) proportions of the first signal and the first signal subject to one or more effects processes of the mixed signal; and (ii) one or more parameters of the one or more effects processes to which the first signal is subject.

30. The method of claim 29, wherein the one or more effect processes include at least one of (i) a delay effect and the one or more parameters include a length of delay; (ii) a flange effect and the one or more parameters include a modulation rate; and (iii) a sample/playback effect and the one or more parameters include at least one of a sample rate and a pitch.

31 A method, comprising:
selecting a program signal and a cue signal using an audio mixer such that an audience is capable of hearing the program signal but not the cue signal;
producing a first mixed signal using the audio mixer, the first mixed signal including a cue signal and the cue signal subject to an effect process;
monitoring the first mixed signal via a headphone (or booth) output of the mixer such that the audience is not capable of hearing the first mixed signal;
producing a second mixed signal using the audio mixer, the second mixed signal including the first signal and the first signal subject to the effect process;
monitoring the second mixed signal via a headphone (or booth) output of the mixer such that the audience is not capable of hearing the second mixed signal;
cross fading between the program signal and the cue signal using a cross fader of the mixer to produce a third mixed signal including the program signal and the cue signal; and
producing a mix of the third mixed signal and the third mixed signal subject to the effect process such that the audience is capable of hearing the mix.

32. The method of claim 31, wherein the producing and monitoring step of the first mixed signal includes adjusting at least one of (i) proportions of the second signal and the second signal subject to the effects process included in the first mixed signal; and (ii) one or more parameters of the effects process to which the second signal is subject.

33. The method of claim 32, wherein the effect process includes at least one of (i) a delay effect and the one or more parameters include a length of delay; (ii) a flange effect and the one or more parameters include a modulation rate; and (iii) a sample/playback effect and the one or more parameters include at least one of a sample rate and a pitch.

34. The method of claim 31, wherein the producing and monitoring step of the second mixed signal includes adjusting at least one of (i) proportions of the first signal and the first signal subject to the effects process included in the second mixed signal; and (ii) one or more parameters of the effects process to which the first signal is subject.

35. The method of claim 34, wherein the effect process includes at least one of (i) a delay effect and the one or more parameters include a length of delay; (ii) a flange effect and the one or more parameters include a modulation rate; and (iii) a sample/playback effect and the one or more parameters include at least one of a sample rate and a pitch.
